(19) United States
(12) Patent Application Publication
(10) Pub. No.: US 2026/0213563 A1
(43) Pub. Date: Jul. 23, 2026

(54) SYSTEM VOLTAGE RIPPLE REDUCTION

(71) Applicant: QUALCOMM Incorporated, San Diego, CA (US)

(72) Inventors: Jialei XU, Santa Clara, CA (US); Joseph Dale RUTKOWSKI, Chandler, AZ (US); Todd Robert SUTTON, Del Mar, CA (US)

(21) Appl. No.: 19/033,810

(22) Filed: Jan. 22, 2025

(51) Int. Cl. H02J 7/00; H02M 1/15

(52) U.S. Cl. CPC H02J 7/94; H02J 7/80; H02J 7/855; H02M 1/15; H02J 2207/20

(57) ABSTRACT

Certain aspects of the present disclosure are directed towards techniques and apparatus for reducing ripple voltage. For example, an example power supply circuit of the present disclosure generally includes: a charger coupled to a battery port configured to be coupled to a battery; a frequency detector configured to detect a frequency at which the power supply circuit enters and exits a current limit condition for the charger or a battery supplement mode in which the battery is configured to supplement power provided to a load by the charger; a frequency comparator configured to determine whether the frequency is within a configured frequency range; and a ripple reduction circuit configured to decrease a current or voltage limit associated with the charger based on the frequency being within the configured frequency range.

### TECHNICAL FIELD

Certain aspects of the present disclosure generally relate to power supply circuits and, more particularly, to techniques and apparatus for supplying power to a load.

### BACKGROUND

A voltage regulator ideally provides a constant direct current (DC) output voltage regardless of changes in load current or input voltage. Voltage regulators may be classified as linear regulators or switching regulators. While linear regulators tend to be relatively compact, many applications may benefit from the increased efficiency of a switching regulator. A switching regulator (also known as a “switching converter” or “switcher”) may be implemented, for example, by a switched-mode power supply (SMPS), such as a buck converter, a boost converter, a buck-boost converter, or a charge pump.

Power management integrated circuits (power management ICs or PMICs) are used for managing the power scheme of a host system and may include and/or control one or more voltage regulators (e.g., buck converters or charge pumps). A PMIC may be used in battery-operated devices, such as mobile phones, tablets, laptops, wearables, etc., to control the flow and direction of electrical power in the devices. The PMIC may perform a variety of functions for the device such as DC-to-DC conversion (e.g., using a voltage regulator as described above), battery charging, power-source selection, voltage scaling, power sequencing, etc. A charger used for battery charging may include a regulator for generating a system voltage (Vsys) at an output coupled to a load.

### SUMMARY

The systems, methods, and devices of the disclosure each have several aspects, no single one of which is solely responsible for its desirable attributes. Without limiting the scope of this disclosure as expressed by the claims that follow, some features are discussed briefly below. After considering this discussion, and particularly after reading the section entitled “Detailed Description,” one will understand how the features of this disclosure provide the advantages described herein.

Certain aspects of the present disclosure are directed towards a power supply circuit. The power supply circuit generally includes: a charger coupled to a battery port configured to be coupled to a battery; a frequency detector configured to detect a frequency at which the power supply circuit enters and exits a current limit condition for the charger or a battery supplement mode in which the battery is configured to supplement power provided to a load by the charger; a frequency comparator configured to determine whether the frequency is within a configured frequency range; and a ripple reduction circuit configured to decrease a current or voltage limit associated with the charger based on the frequency being within the configured frequency range.

Certain aspects of the present disclosure are directed towards a method for supplying power. The method generally includes: detecting a frequency at which a power supply circuit enters and exits a current limit condition for a charger or a battery supplement mode in which a battery supplements power provided to a load by the charger; determining whether the frequency is within a configured frequency range; and decreasing a current or voltage limit associated with the charger based on the frequency being within the configured frequency range.

Certain aspects of the present disclosure are directed towards an apparatus for supplying power. The apparatus generally includes: means for detecting a frequency at which a power supply circuit enters and exits a current limit condition for a charger or a battery supplement mode in which a battery supplements power provided to a load by the charger; means for determining whether the frequency is within a configured frequency range; and means for decreasing a current or voltage limit associated with the charger based on the frequency being within the configured frequency range.

Certain aspects of the present disclosure are directed towards an electronic device. The electronic device generally includes a battery, one or more circuits, and a power supply circuit comprising: a charger coupled to the battery; a frequency detector configured to detect a frequency at which the power supply circuit enters and exits a current limit condition for the charger or a battery supplement mode in which the battery is configured to supplement power provided to the one or more circuits by the charger; a frequency comparator configured to determine whether the frequency is within a configured frequency range; and a ripple reduction circuit configured to decrease a current or voltage limit associated with the charger based on the frequency being within the configured frequency range.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram of an example device that includes a power management integrated circuit (PMIC) and a battery charging circuit, in which aspects of the present disclosure may be practiced.

FIG. 2 illustrates a power supply circuit with a charger used to charge a battery, in accordance with certain aspects of the present disclosure.

FIG. 3 is a timing diagram showing states of components and signals of the power supply circuit operated with voltage tracking, in accordance with certain aspects of the present disclosure.

FIG. 4 is a timing diagram showing states of components and signals of the power supply circuit operated with fixed voltage regulation, in accordance with certain aspects of the present disclosure.

FIG. 5 is a block diagram of a ripple control circuit, in accordance with certain aspects of the present disclosure.

FIG. 6 is a timing diagram illustrating example techniques for ripple voltage reduction by decreasing a maximum regulated voltage threshold, in accordance with certain aspects of the present disclosure.

FIG. 7 is a flow diagram illustrating example operations for ripple voltage reduction by decreasing a maximum regulated voltage threshold, in accordance with certain aspects of the present disclosure.

FIG. 8 is a timing diagram illustrating example techniques for ripple voltage reduction by decreasing a maximum regulated voltage threshold using a shorter ramp-down time as compared to a ramp-up time, in accordance with certain aspects of the present disclosure.

FIG. 9 is a timing diagram illustrating example techniques for ripple voltage reduction by decreasing an input current limit (ICL), in accordance with certain aspects of the present disclosure.

FIG. 10 is a flow diagram illustrating example operations for voltage ripple reduction by decreasing ICL, in accordance with certain aspects of the present disclosure.

FIG. 11 is a timing diagram illustrating example techniques for ripple voltage reduction by decreasing ICL using a shorter ramp-down time as compared to a ramp-up time, in accordance with certain aspects of the present disclosure.

FIG. 12 is a flow diagram illustrating example operations for supplying power, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure are directed towards techniques for reducing ripple voltage for a power supply circuit. The power supply circuit may include a charger to charge a battery. The charger may be coupled to a voltage sense node in order for the charger to sense the voltage of the battery. In some scenarios, the voltage sense node of the power supply circuit may become a high-impedance node. For example, the sense node may be coupled to the battery through a charge-field-effect transistor (C-FET). When the battery is not being charged, the C-FET may be open, not allowing any current to be sunk from the sense node via a path to the battery making the sense node a high-impedance node. The power supply circuit may then enter an input current limit (ICL) condition or battery supplement mode (BSM) due to high power draw from a load. When the power supply circuit exits the ICL condition or BSM, there may be an inrush of current from the charger to the high-impedance node, causing a voltage spike or ripple. In some cases, the power supply circuit may enter and exit the ICL condition or BSM at a rate that is within an audible frequency range (e.g., 20 Hz to 20 kHz). Thus, a set of voltage ripples may occur at a rate that is within the audible frequency range, causing noise from the power supply circuit.

In some aspects of the present disclosure, the noise from the power supply circuit may be reduced. For example, the power supply circuit may identify when the circuit is entering and exiting the ICL condition or BSM at the frequency within the audible frequency range. In response, the power supply circuit may take action to allow the battery to supplement more power to the load to prevent the power supply circuit from constantly entering and exiting the ICL condition or BSM. For instance, the power supply circuit may decrease (e.g., using discrete steps) the ICL to allow the battery to supplement more power to the load. As another example, the power supply circuit may implement a maximum regulated voltage value that sets the maximum of a regulated output voltage (e.g., system voltage (Vsys)) to be generated by the charger. The power supply circuit may decrease the maximum regulated voltage value to allow the battery to supplement more power to the load.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

### An Example Device

It should be understood that aspects of the present disclosure may be used in a variety of applications. Although the present disclosure is not limited in this respect, the circuits disclosed herein may be used in any of various suitable apparatus, such as in the power supply, battery charging circuit, or power management circuit of a communication system, a video codec, audio equipment such as music players and microphones, a television, camera equipment, and test equipment such as an oscilloscope. Communication systems intended to be included within the scope of the present disclosure include, by way of example only, cellular radiotelephone communication systems, satellite communication systems, two-way radio communication systems, one-way pagers, two-way pagers, personal communication systems (PCS), personal digital assistants (PDAs), and the like.

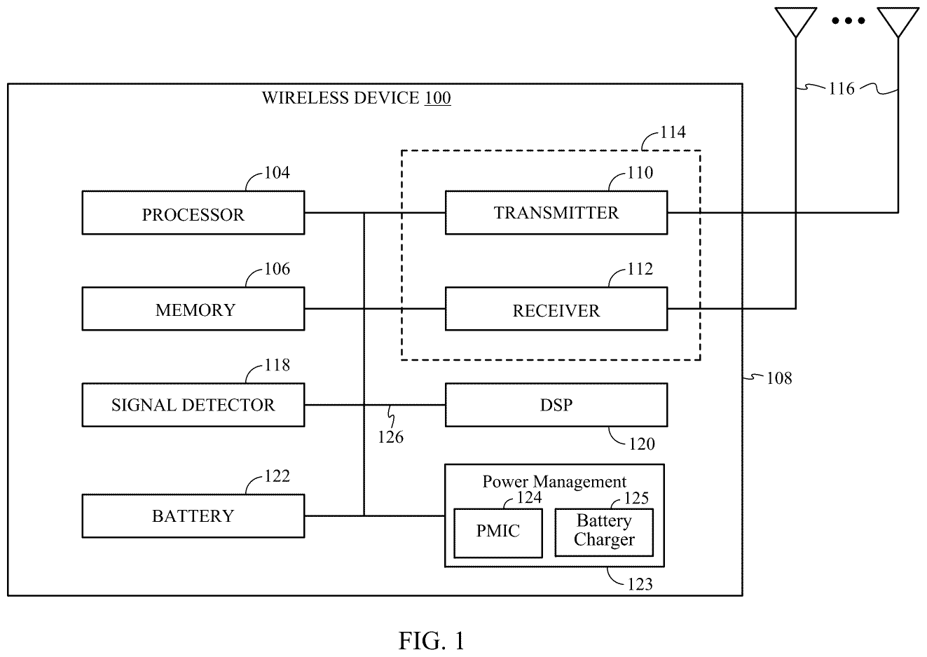

FIG. 1 illustrates an example device 100 in which aspects of the present disclosure may be implemented. The device 100 may be a battery-operated device such as a cellular phone, a PDA, a handheld device, a wireless device, a laptop computer, a tablet, a smartphone, an Internet of things (IoT) device, a wearable device, etc. For certain aspects, the device 100 may be a foldable device (e.g., a flip phone).

The device 100 may include a processor 104 that controls operation of the device 100. The processor 104 may also be referred to as a central processing unit (CPU). Memory 106, which may include both read-only memory (ROM) and random access memory (RAM), provides instructions and data to the processor 104. A portion of the memory 106 may also include non-volatile random access memory (NVRAM). The processor 104 typically performs logical and arithmetic operations based on program instructions stored within the memory 106.

In certain aspects, the device 100 may also include a housing 108 that may include a transmitter 110 and a receiver 112 to allow transmission and reception of data between the device 100 and a remote location. For certain aspects, the transmitter 110 and receiver 112 may be combined into a transceiver 114. One or more antennas 116 may be attached or otherwise coupled to the housing 108 and electrically connected to the transceiver 114. The device 100 may also include (not shown) multiple transmitters, multiple receivers, and/or multiple transceivers.

The device 100 may also include a signal detector 118 that may be used in an effort to detect and quantify the level of signals received by the transceiver 114. The signal detector 118 may detect such signal parameters as total energy, energy per subcarrier per symbol, and power spectral density, among others. The device 100 may also include a digital signal processor (DSP) 120 for use in processing signals.

The device 100 may further include a battery 122, which may be used to power the various components of the device 100 (e.g., when another power source—such as a wall adapter or a wireless power charger—is unavailable). The battery 122 may comprise a single cell or multiple cells connected in series and/or in parallel. The device 100 may further include additional independent batteries (not shown). Each of the additional independent batteries may comprise a single cell or multiple cells connected in series and/or in parallel.

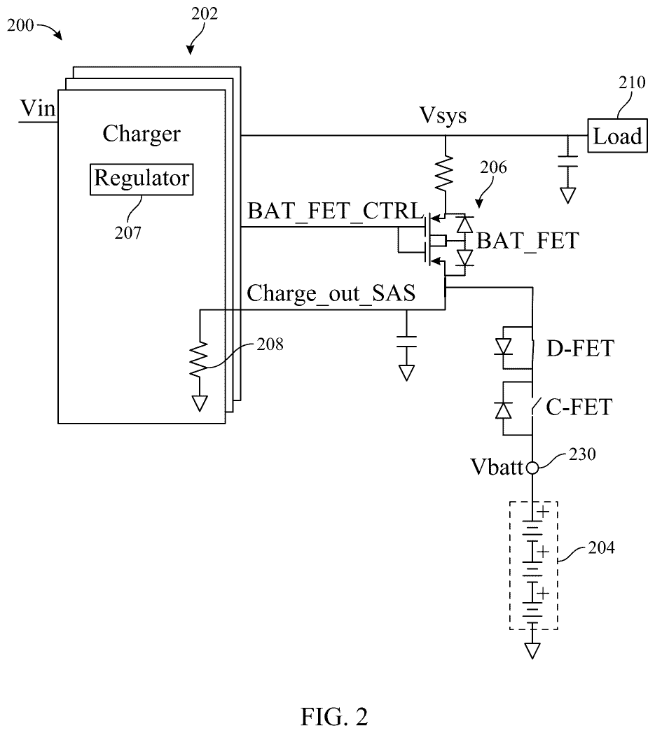

The device 100 may also include a power management system 123 for managing the power from the battery 122 (or batteries), a wall adapter, and/or a wireless power charger to the various components of the device 100. The power management system 123 may perform a variety of functions for the device such as DC-to-DC conversion, battery charging, power-source selection, voltage scaling, power sequencing, source mode power, etc. In certain aspects, the power management system 123 may include a power management integrated circuit (power management IC or PMIC) 124 and one or more power supply circuits, such as a battery charger 125, which may be controlled by the PMIC or logic associated with the battery charger, for example. For certain aspects, at least a portion of one or more of the power supply circuits (e.g., at least a portion of the battery charger 125) may be integrated in the PMIC 124. The PMIC 124 and/or the one or more power supply circuits may include at least a portion of a switched-mode power supply (SMPS) circuit, which may be implemented by any of various suitable switched-mode power supply circuit topologies, such as a two-level buck converter, a three-level buck converter, a charge pump, or an adaptive combination power supply circuit (e.g., the SMPS circuit 214 of FIG. 2). In some aspects, the PMIC may be implemented with a ripple voltage reduction circuit as described in more detail herein.

The various components of the device 100 may be coupled together by a bus system 126, which may include a power bus, a control signal bus, and/or a status signal bus in addition to a data bus. Additionally or alternatively, various combinations of the components of the device 100 may be coupled together by one or more other suitable techniques.

### Example Techniques for Ripple Voltage Reduction

Certain aspects of the present disclosure are directed towards a power supply circuit, including a battery charger. The charger may generate a system voltage (Vsys) that may be regulated to a voltage (e.g., also referred to as a tracking voltage) above a battery voltage (Vbatt) or regulated to a fixed voltage (e.g., referred to herein as a floating voltage (Vfloat)) based on Vbatt. In some chargers, a charging field-effect transistor (C-FET) between a voltage sense node (also referred to herein as a charging output sense node) of the charger and the battery may be turned off after charging is terminated to cut off the charging path to the battery. As a result, the battery output voltage node may be unable to sink current from the voltage sense node, causing a floating or high-impedance condition at the voltage sense node. If the power draw from the load coupled to the charger exceeds an input power (current) limit of the charger, the charger may enter an input current limit (ICL) condition or a battery supplement mode (BSM) and Vsys may drop to a diode voltage (Vdiode) below Vbatt. Upon exiting the ICL condition or BSM, a voltage spike or a ripple (e.g., 600 mV ripple) may occur. When the amount of power being drawn by the load is close to the input power limit, the power supply circuit may enter and exit the ICL condition or BSM, causing a series of ripples that may cause audible noise. Certain aspects of the present disclosure are directed towards techniques for reducing the ripple voltage to reduce the audible noise, as described in more detail herein.

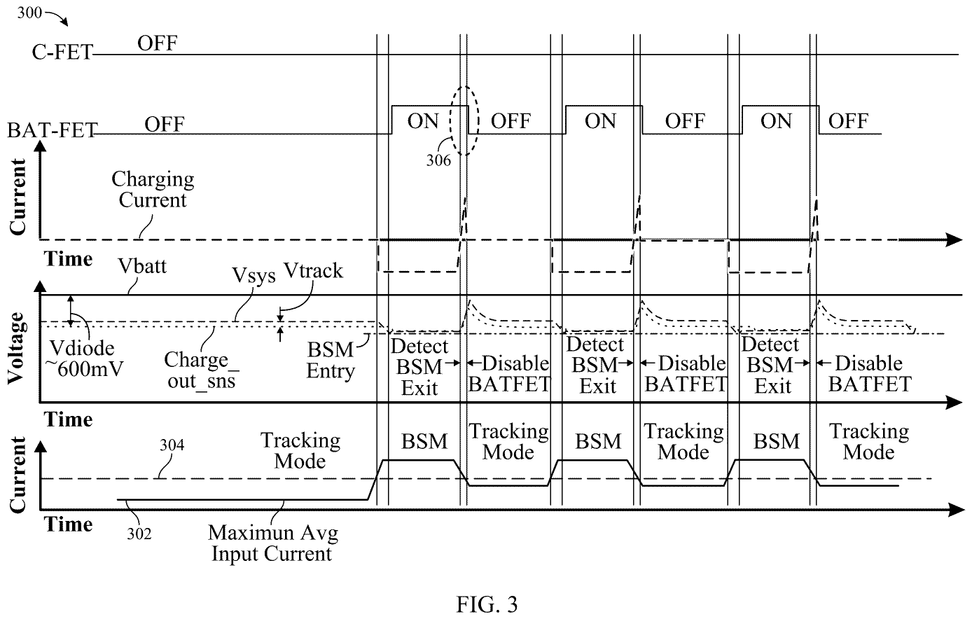

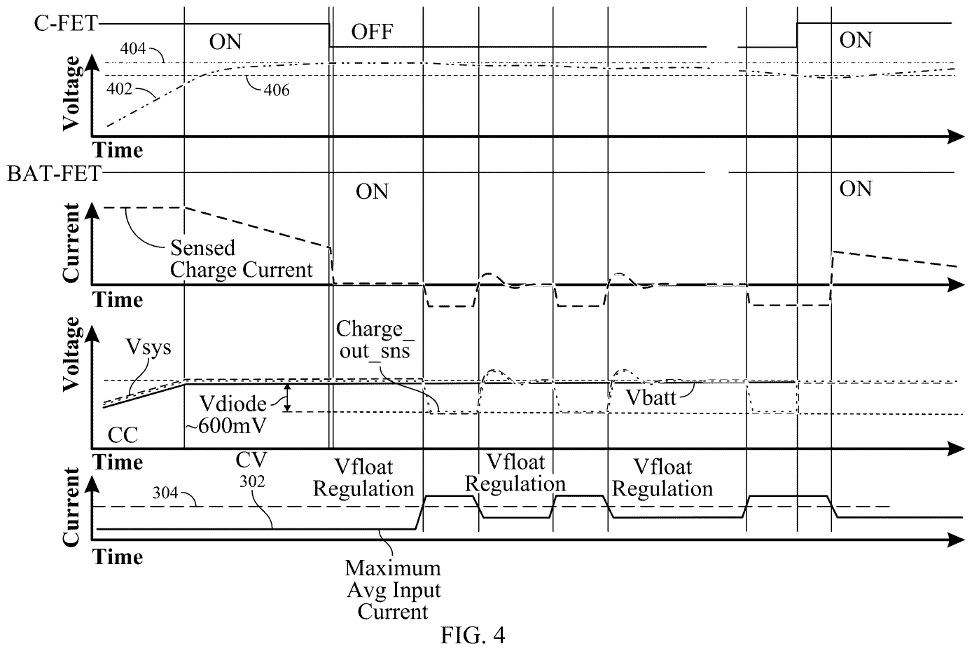

FIG. 2 illustrates a power supply circuit 200 including a charger 202 used to charge a battery 204 (e.g., a battery stack). The charger 202 may receive an input voltage (Vin) and generate, via a regulator 207, Vsys at an output node (e.g., Vsys node) coupled to a load 210. The charger 202 may regulate Vsys to a voltage (e.g., referred to as a tracking voltage (Vtrack)) above a sensed battery voltage (Vbatt) as described in more detail with respect to FIG. 3 or may generate a fixed voltage (Vfloat) based on the sensed Vbatt as described in more detail with respect to FIG. 4.

The battery voltage (Vbatt) may be sensed at a charging output sense (labeled “charge_out_sns”) node. A battery FET 206 (BAT_FET) may be coupled between the Vsys node and the charge_out_sns node, as shown. As shown, the FET 206 may be implemented using back to back FETs with body diodes pointing to opposite directions in series to allow bidirectional current flow for battery charging and supplementing power to a load via the battery. The charger 202 may control the FET 206 via a battery FET control (BAT_FET_CTRL) signal, as shown. The charge_out_sns node may be coupled to a battery port 230 (e.g., coupled to the battery 204) through a discharge FET (labeled “D-FET”) and a charge FET (labeled “C-FET”). The charge_out_sns node may be coupled to a reference potential node (e.g., electric ground) through a resistive element 208 of the charger 202.

FIG. 3 is a timing diagram 300 showing states of components and signals of the power supply circuit 200 operated with voltage tracking, in accordance with certain aspects of the present disclosure. As shown in timing diagram 300, during a tracking mode of operation, Vsys may be greater than (e.g., by 50 mV) but track the charge_out_sns voltage. Vbatt may be greater than the charge_out_sns voltage by Vdiode which may be 600 mV.

The C-FET (e.g., C-FET switch) may be turned off (e.g., opened) after the charging of the battery has been terminated to cut off the charging path to the battery 204. The charging current may be zero when the C-FET is turned off. Thus, current may not sink to the battery from the charge_out_sns node, causing the charge_out_sns node to be a high-impedance node (e.g., also referred to herein as a floating charge_out_sns node or a high-impedance charge_out_sns node).

As described, load 210 may consume power, causing an ICL condition for the charger. For example, curve 302 may represent the maximum of the average input current of the charger 202. Once the maximum of the average input current exceeds an ICL 304, the charger may enter the ICL condition. In some cases, after or in response to entering the ICL condition, the power supply circuit 200 may enter a battery supplement mode (BSM) where the battery begins to supplement the power to the load. As shown, the charging current (e.g., corresponding to a current across FET 206) may be negative due to the current flowing to the load from the battery. The negative charging current may be, in effect, a battery discharge current referred to herein as “IBAT_DISCHG.” Vsys and the charge_out_sns voltage may drop to Vdiode below Vbatt, as shown. Vdiode may be the forward voltage drop of a diode, such as the diode of the C-FET, which may be 600 mV. In BSM, the BAT_FET (FET 206) turns on to facilitate the power delivery to the load from the battery.

Once the maximum of the average input current drops below the ICL 304, the charger may exit the ICL condition, and current may flow from the charger 202 (e.g., Vsys node) to the high-impedance charge_out_sns node, causing a potentially greater than 600 mV voltage spike at the Vsys node and the charge_out_sns node, as shown. This may be due to a delay from when the charger 202 exits the ICL condition (or BSM) and when the BAT_FET (FET 206) turns off at time 306, providing a path for current flow from the charger 202 to the high-impedance charge_out_sns node.

The power draw from the load may cause a boundary condition for the ICL. That is, the maximum of the average input current represented by curve 302 may transition back and forth above and below the ICL 304. Thus, the power supply circuit 200 may transition back and forth between BSM and tracking mode, causing ripples at a particular frequency. In some cases, this frequency may be within an audible frequency range, causing an audible noise to be emitted from the power supply circuit. Certain aspects of the present disclosure are directed towards reducing (or eliminating) the ripple voltages within the audible frequency range to prevent (or at least reduce) the audible noise.

FIG. 4 is a timing diagram showing states of components and signals of the power supply circuit 200 operated with fixed voltage regulation, in accordance with certain aspects of the present disclosure. As shown, when the battery cell voltage 402 reaches an end of charge threshold 404, charging may be terminated by turning off C-FET, and when the voltage 402 reaches a charge threshold 406, charging may begin by turning on C-FET. As shown, the BAT_FET (FET 206) may be on during both the charging and non-charging conditions.

During a constant current (CC) mode, the charge current may be constant. Thus, Vsys, the charge_out_sns voltage, and Vbatt may increase. During a constant voltage (CV) mode, the charger 202 may regulate Vsys to be a fixed voltage (Vfloat) greater than Vbatt.

As shown, when the maximum of the average input current of the charger 202 increases above the ICL 304, Vsys drops to Vdiode below Vbatt. With the charge_out_sns node being a high-impedance node, when the ICL condition ends, Vsys and the charge_out_sns voltage increase above Vbatt, causing a ripple voltage. As described, the power drawn from load 210 may cause a boundary condition for the input current limit, causing ripples at an audible frequency range and resulting in an audible noise from the power supply circuit. Certain aspects of the present disclosure are directed towards reducing (or eliminating) the ripple voltage within the audible frequency range to prevent (or at least reduce) the audible noise. For example, a ripple reduction circuit may detect an event where an ICL and/or BSM event occur frequently at a rate within a specified frequency range (e.g., audible frequency range). In response to the detection, a circuit may be used to reduce or eliminate the voltage ripples occurring at the rate that is within the frequency range.

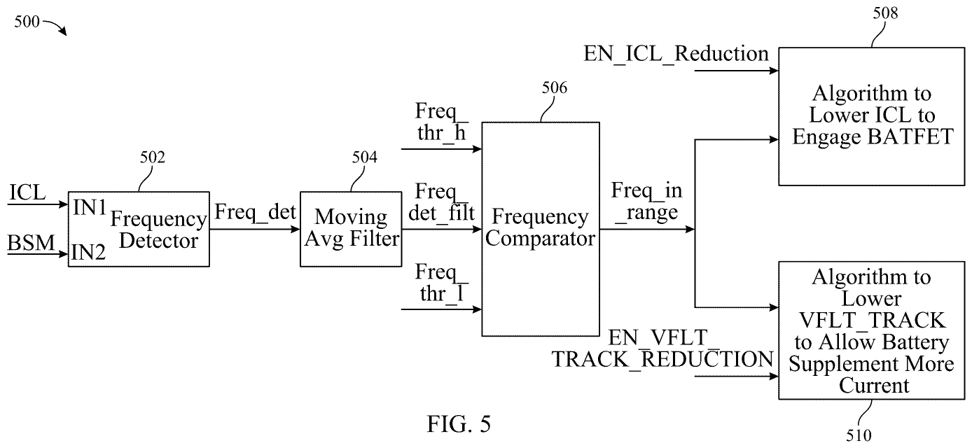

FIG. 5 is a block diagram of a ripple control circuit 500, in accordance with certain aspects of the present disclosure. In some cases, the ripple control circuit 500 may be implemented as part of the charger 202.

The circuit 500 may include a frequency detector 502 with a first input (IN1) receiving an indication of entering and exiting an ICL condition and a second input (IN2) receiving an indication of entering and exiting BSM. The frequency detector may detect the frequency associated with entering and exiting ICL (and/or entering and exiting BSM) to generate a frequency detection (Freq_det) signal. A moving average of the Freq_det signal may be performed to generate a filtered frequency detection (Freq_det_filt) signal, which may be compared to a high frequency threshold (Freq_thr_h) and a low frequency threshold (Freq_thr_l) via a frequency comparator 506.

The high and low frequency thresholds may define an audible frequency range as described herein. If the Freq_det_filt signal is between the high and low frequency thresholds, one of two possible ripple reduction circuits (e.g., algorithms) may be activated. For example, a first ripple reduction circuit 508 may be implemented that lowers the ICL (e.g., ICL 304) to allow the battery to supply more current to the load. For example, referring to FIG. 3, the ICL 304 may be decreased until the BAT_FET (FET 206) closes and remains closed (e.g., the power supply circuit does not enter and exit BSM at a rate within the audible frequency range). A second ripple reduction circuit 510 may be implemented by decreasing a maximum Vfloat threshold (e.g., referred to herein as “VFLT_TRACK”) for the charger 202. The VFLT_TRACK may be a value that sets a maximum voltage to which the charger 202 may regulate Vsys. The VFLT_TRACK may provide a ceiling (e.g., limit) for voltage regulation by the charger 202. Thus, VFLT_TRACK may also be referred to herein as a “voltage limit.” The second ripple reduction circuit 510 may decrease VFLT_TRACK to allow the battery to supplement more current so that the charger 202 does not enter and exit the ICL condition at a rate within the audible frequency range.

As shown, the frequency comparator 506 generates a frequency in range (“Freq_in_range”) signal that indicates whether the rate at which the charger enters and exits ICL (or the power supply circuit 200 enters and exits BSM) is within the frequency range. One of ripple reduction circuits 508, 510 may be enabled via an enable ICL circuit (EN_ICL_Reduction) signal and an enable Vfloat track algorithm (EN_VFLT_TRACK_Reduction) signal, respectively. The enabled ripple reduction circuit may be used in response to receiving the Freq_in_range signal. For instance, the ICL of the charger 202 may be decreased dynamically when the charger enters and exits the ICL condition until BSM is engaged to close the BAT_FET. Then, the ICL may be increased back to a maximum value if the BSM condition is cleared (e.g., and remains cleared once the ICL is increased), as described in more detail herein. In some cases, the power supply circuit 200 may dynamically lower VFLT_TRACK so that the battery can provide more current to the Vsys node (e.g., causing battery discharge) in a load attack condition until the ICL condition is cleared. Then, the power supply circuit 200 may increment the VFLT_TRACK once the load attack condition ends until the battery discharge current returns to zero, as described in more detail herein.

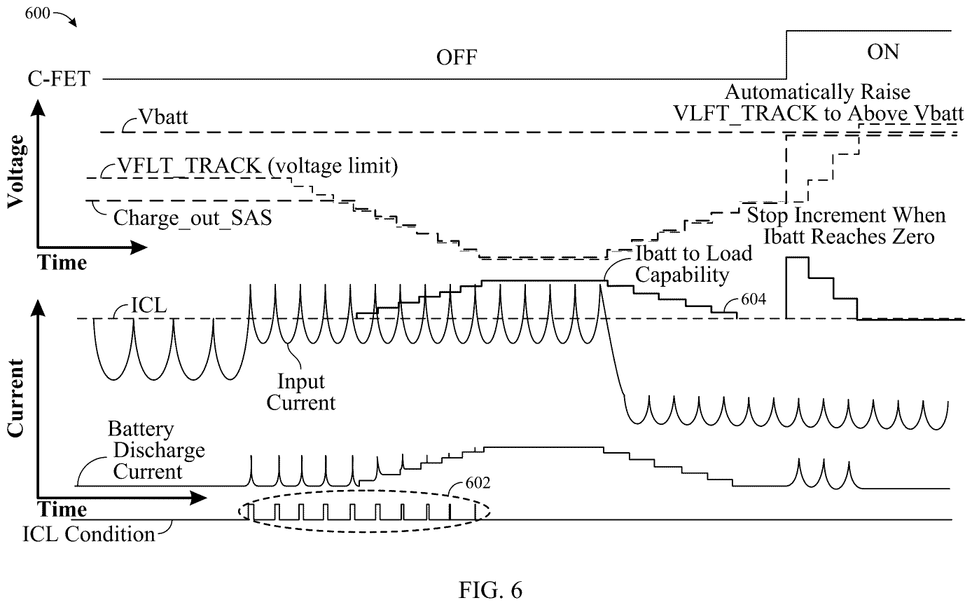

FIG. 6 is a timing diagram 600 illustrating example techniques for voltage ripple reduction by reducing the VFLT_TRACK, in accordance with certain aspects of the present disclosure. VFLT_TRACK may be reduced in discrete steps, in some cases.

As shown, VFLT_TRACK may be initially set to a maximum VFLT_TRACK level (VFLT_TRACK_MAX). An ICL condition may occur when an input current (Iin) of the charger 202 (e.g., current received at the Vin node of charger 202) is greater than the ICL. When the ICL condition occurs, the battery discharge current spikes due to the battery supplementing the current to the load, as shown. The charger may enter and exit the ICL condition at a particular frequency which may be within the audible frequency range, as described. Based on the rate at which ICL conditions 602 occur, VFLT_TRACK may be decreased (e.g., decremented by discrete steps). In some cases, VFLT_TRACK may be decremented by 30 mV/step, or 20 mV/step. Assuming a 150 mΩ equivalent series resistance (ESR) for the battery, each time the VFLT_TRACK is decremented, the battery current (Ibatt) capability (represented by curve 604) to the load may increase by about 200 mA, as shown. That is, once VFLT_TRACK drops below the charge_out_sns voltage, the Ibatt to load capability may increase. As a result, the battery discharge current also increases as the battery begins supplying more current to the load.

VFLT_TRACK may continue to be decreased until the ICL conditions no longer occur (or no longer occur at a rate within the audible frequency range). For example, the power supply circuit 200 may stop decrementing VFLT_TRACK when the power supply circuit 200 is no longer operating within the ICL condition. The power supply circuit 200 may then periodically increment the VFLT_TRACK by one step, wait a certain period of time (e.g., 200 ms), and then decrement by one step as a way to check whether the ICL condition will return due to the VFLT_TRACK being incremented. If the ICL condition does not return after incrementing by one step, the VFLT_TRACK may be incremented in discrete steps until Ibatt (battery discharge current) returns to zero.

As described with respect to FIG. 4, when the power supply circuit 200 is operated with fixed voltage regulation, BAT_FET (FET 206) may remain turned on. Thus, if C-FET is turned on for charging as shown in FIG. 6 (e.g., resulting in the charge_out_sns voltage increasing close to Vbatt), the battery may begin supplying current to the Vsys node through C-FET and FET 206. Thus, the power supply circuit may automatically raise VFLT_TRACK to above Vbatt until the battery discharge current reaches zero. In other words, VFLT_TRACK is increased to above Vbatt to allow the charger to charge the battery.

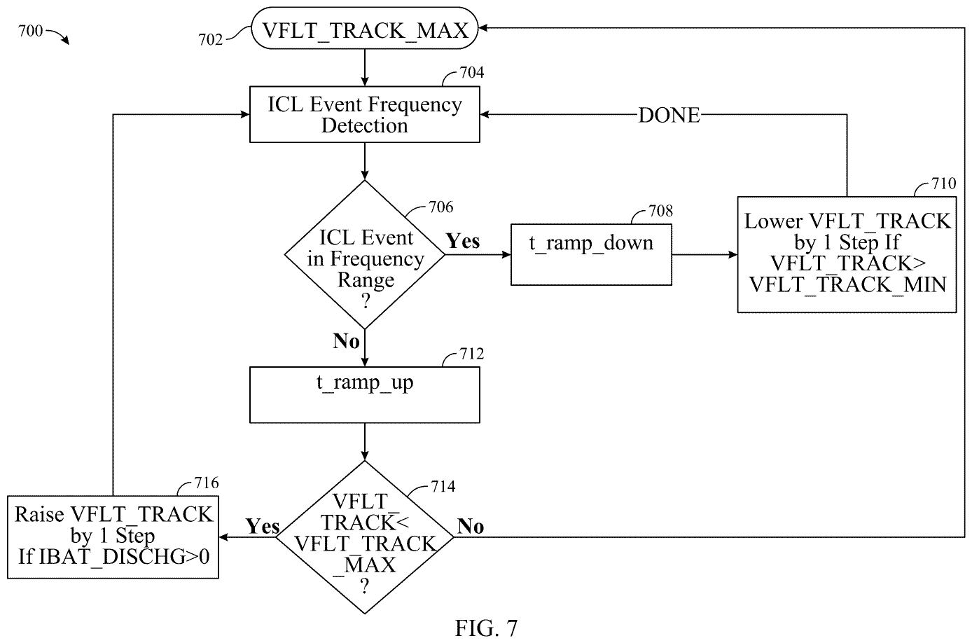

FIG. 7 is a flow diagram illustrating example operations 700 for ripple reduction by decreasing VFLT_TRACK, in accordance with certain aspects of the present disclosure. The operations 700 may be performed, by a ripple reduction circuit, such as the ripple reduction circuit 510 of FIG. 5.

In some aspects, a maximum VFLT_TRACK (VFLT_TRACK_MAX) and a minimum VFLT_TRACK (VFLT_TRACK_MIN) may be configured (e.g., programmed) for the charger 202, providing upper and lower limits for VFLT_TRACK. Moreover, a ramp-down time (t_ramp_down) may be configured, which may be referred to as a deglitch time for the VFLT_TRACK countdown. That is, t_ramp_down may be the time between each decrement step for the VFLT_TRACK, which may be between 1 and 20 ms. A ramp-up time (t_ramp_up) may also be configured (e.g., programmed), which may be the deglitch time for VFLT_TRACK count up.

As shown, at block 702, VFLT_TRACK may be set to VFLT_TRACKMAX. At block 704, the power supply circuit may detect the frequency at which the ICL conditions or events occur. At block 706, the power supply circuit may determine whether the frequency is within a specified frequency range (e.g., audible frequency range). If so, after a delay at block 708 per the configured ramp-down time (t_ramp_down), the power supply circuit may lower VFLT_TRACK by one discrete step if VFLT_TRACK is greater than the configured VFLT_TRACK_MIN value. This process may be repeated until the power supply circuit no longer detects, at block 706, that the frequency of ICL conditions is within the frequency range. Then, the power supply circuit may delay for the configured ramp-up time (t_ramp_up) at block 712, then determine, at block 714, whether VFLT_TRACK is less VFLT_TRACK_MAX. If so, at block 716, the power supply circuit may increase (raise) VFLT_TRACK by one discrete step if the battery discharge current (IBAT_DISCHG) is greater than zero. This process may continue until ICL conditions at a rate within the frequency range again start to occur, VFLT_TRACK reaches the VFLT_TRACK_MAX, or IBAT_DISCHG reaches zero.

In some aspects, a slower time step may be used for the ramp-up time (e.g., ramp-up time of 100 ms to 1 s) as compared to the ramp-down time. That is, to avoid switching in and out of the ripple reduction operations, VFLT_TRACK may be slowly increased (e.g., returned to VFLT_TRACK_MAX or a state in which IBAT_DISCHG is close to zero). The quicker ramp-down time allows the power supply circuit to stop any audible noise more quickly due to the ICL conditions occurring within the audible frequency range. However, a slower ramp-up time may be used to give the power supply circuit sufficient time to react to changing conditions that may potentially retrigger ICL conditions.

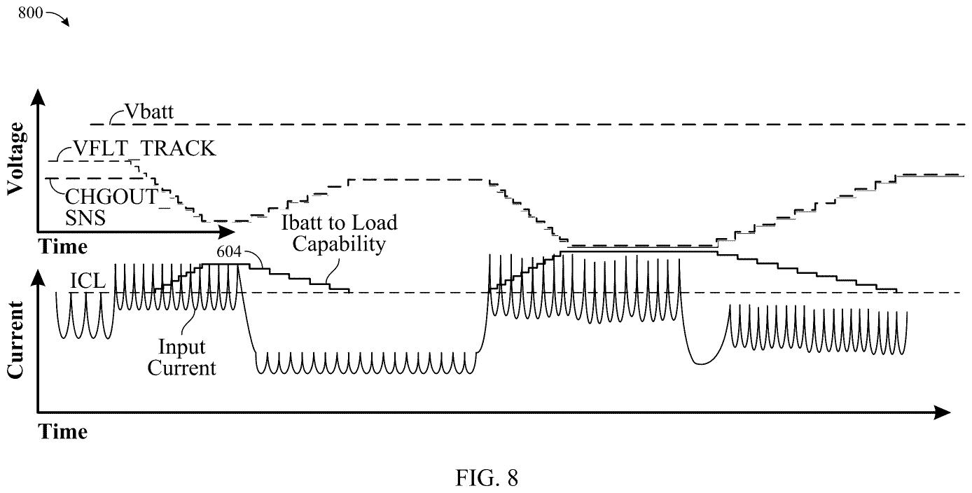

FIG. 8 is a timing diagram 800 illustrating example techniques for voltage ripple reduction by reducing the maximum Vfloat threshold (VFLT_TRACK) using a shorter ramp-down time as compared to a ramp-up time, in accordance with certain aspects of the present disclosure. Upon detection of ICL conditions at a frequency within a specified frequency range, VFLT_TRACK may be decreased by discrete steps. As described, after the input current of the charger has decreased (e.g., load power draw has decreased), VFLT_TRACK may be increased by discrete steps. As described, a longer delay may be included between each time VFLT_TRACK is incremented than when VFLT TRACK is decremented.

In certain aspects, the power supply circuit may reduce the ICL of the charger 202 to engage the FET 206. That is, Vsys ripple issue may be mitigated by reducing the ICL to allow BSM to engage without constantly entering and exiting BSM at a rate within the audible frequency range causing noise.

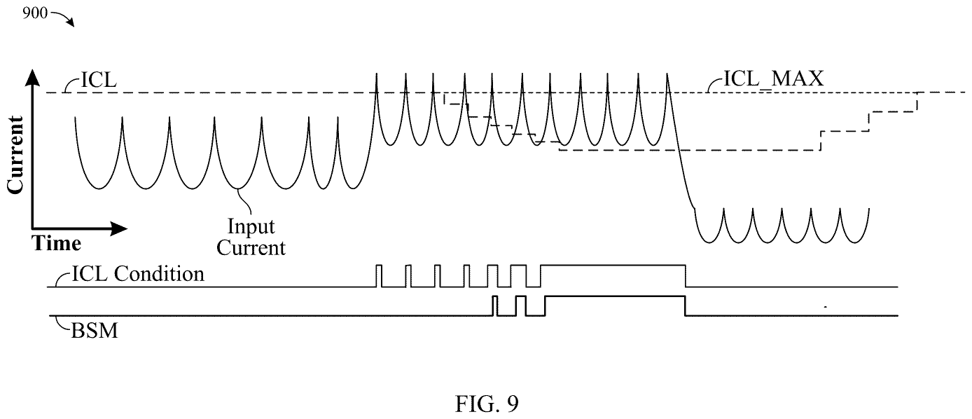

FIG. 9 is a timing diagram 900 illustrating example techniques for ripple reduction by decreasing ICL, in accordance with certain aspects of the present disclosure. As shown, the power supply circuit may start from a maximum ICL (ICL_MAX) and begin decrementing the ICL when the ICL conditions occur at a rate within the audible frequency range (e.g., even if BSM has not yet been entered). As described, in some cases, the power supply circuit may determine whether to decrease ICL based on the rate of entering and exiting BSM. The ICL may be decreased until BSM is triggered without constantly exiting and entering BSM at a rate within the audible frequency range. Once BSM (e.g., and ICL condition) has been exited and after some deglitch time (e.g., ~100 ms), the ICL may be increased (e.g., incrementally) back to ICL_MAX, as shown.

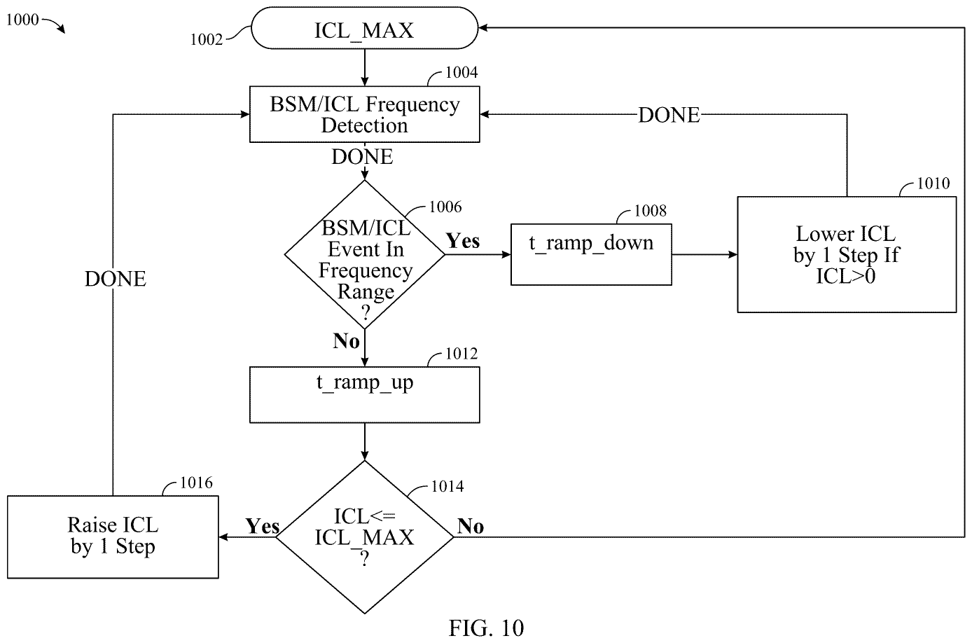

FIG. 10 is a flow diagram illustrating example operations 1000 for ripple reduction by decreasing ICL, in accordance with certain aspects of the present disclosure. The operations 1000 may be performed, by a ripple reduction circuit, such as the ripple reduction circuit 508 of FIG. 5.

In some aspects, a maximum ICL (ICL_MAX) may be configured (e.g., programmed) for the charger 202, providing an upper limit for ICL. Moreover, a ramp-down time (t_ramp_down) may be configured for decreasing ICL, which may be referred to as a deglitch time for the ICL countdown. That is, t_ramp_down may be the time between each decrement step for the ICL. A ramp-up time (t_ramp_up) may also be configured (e.g., programmed) for increasing ICL, which may be the deglitch time for ICL count up.

As shown, at block 1002, ICL may be set to ICL_MAX. At block 1004, the power supply circuit may detect the frequency at which the ICL (or BSM) events occur. At block 1006, the power supply circuit may determine whether the frequency is within a specified frequency range (e.g., audible frequency range). If so, after a delay at block 1008 per the configured ramp-down time (t_ramp_down), the power supply circuit may lower ICL by one discrete step if ICL is greater than zero. This process may be repeated until the power supply circuit no longer detects, at block 1006, that the frequency of ICL (or BSM) events is within the frequency range. Then, the power supply circuit may delay for the configured ramp-up time (t_ramp_up) at block 1012 and then determine, at block 1014, whether ICL is less than ICL_MAX. If so, at block 1016, the power supply circuit may increase (raise) ICL by one discrete step. This process may continue until either the ICL reaches ICL_MAX or the ICL or BSM conditions again begin to occur at a rate within the frequency range.

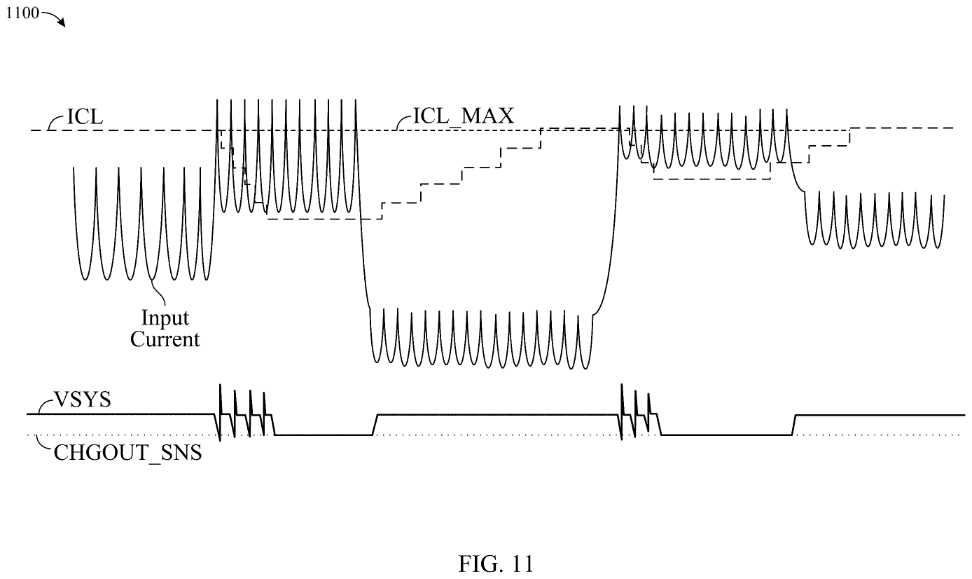

FIG. 11 is a timing diagram 1100 illustrating example techniques for ripple reduction by reducing ICL using a shorter ramp-down time compared to a ramp-up time, in accordance with certain aspects of the present disclosure. The ramp-down time may be programmable and set to 1 to 20 ms and the ramp-up time may be programmable set to 100 ms to 1 s. To avoid switching in and out of the ripple reduction algorithm, the ICL may be slowly increased (e.g., returned to ICL_MAX) when the frequency at which ICL (or BSM) events occur does not fall in the audible frequency range. The quicker ramp-down time may allow the power supply circuit to stop any audible noise more quickly due to the ICL/BSM events occurring within the audible frequency range. However, a slower ramp-up time may be used to give the power supply circuit sufficient time to react to changing conditions that may potentially retrigger an ICL event.

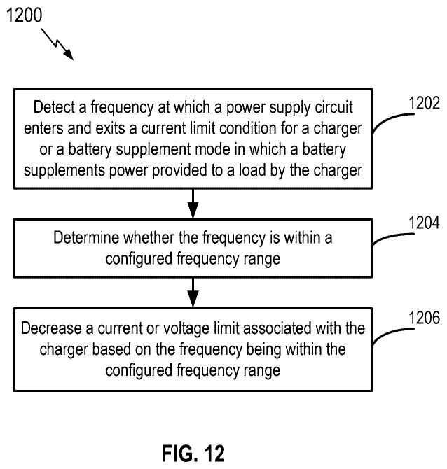

FIG. 12 is a flow diagram illustrating example operations for supplying power, in accordance with certain aspects of the present disclosure. The operations 1200 may be performed, for example, by a power supply circuit such as the power supply circuit 200 and ripple control circuit 500.

At block 1202, the power supply circuit may detect (e.g., via frequency detector 502) a frequency at which the power supply circuit enters and exits (a) a current limit condition (e.g., ICL condition) for the charger or (b) a battery supplement mode in which the battery is configured to supplement power provided to a load by the charger.

At block 1204, the power supply circuit may determine (e.g., via a frequency comparator 506) whether the frequency is within a configured frequency range (e.g., an audible frequency range).

At block 1206, the power supply circuit may decrease (e.g., via a ripple reduction circuit 508 or 509) a current or voltage limit associated with the charger based on the frequency being within the configured frequency range. In some aspects, the ripple reduction circuit may decrease the current or voltage limit in order to increase an amount of current provided from the battery to the load.

In some aspects, a voltage ripple may be generated at an output (Vsys node) of the charger each time the power supply circuit exits the current limit condition or the battery supplement mode, yielding a series of voltage ripples at a ripple frequency that is within the configured frequency range. The ripple reduction circuit may be configured to decrease the current or voltage limit to prevent the series of voltage ripples from occurring at the ripple frequency that is within the configured frequency range. In some aspects, to decrease the current or voltage limit, the ripple reduction circuit may decrease the current or voltage limit by discrete steps.

The ripple reduction circuit may decrease the current or voltage limit until the frequency is no longer within the configured frequency range. In some aspects, the ripple reduction circuit may increase the current or voltage limit after the current or voltage limit is decreased. For example, the ripple reduction circuit may increase the current or voltage limit until: the current or voltage limit reaches a maximum value for the current or voltage limit (e.g., ICL_MAX or VFLT_TRACK_MAX); the frequency at which the power supply circuit enters and exits the current limit condition or the battery supplement mode is determined to be within the configured frequency range while increasing the current or voltage limit; or a discharge current (IBAT_DISCHG) from the battery to supplement power to the load reaches zero. In some aspects, the ripple reduction circuit may: decrease the current or voltage limit using a first set of discrete steps with a first delay (e.g., ramp-down time) between each of the first set of discrete steps; and increase the current or voltage limit using a second set of discrete steps with a second delay (e.g., ramp-up time) between each of the second set of discrete steps, the second delay being greater than the first delay.

In some aspects, the current limit condition comprises an input current limit condition of the charger. The charger may enter the input current limit condition based on a maximum of an average input current to the charger exceeding an input current limit.

In some aspects, the voltage limit (e.g., VFLT_TRACK) may include a maximum of a regulated voltage generated by the charger. The charger may generate the regulated voltage at a voltage output node (Vsys node) of the charger based on the maximum of the regulated voltage.

In some aspects, a first transistor (e.g., FET 206) may be coupled between an output (e.g., Vsys node) of the charger and a voltage sense node (e.g., charge_out_sns node) of the power supply circuit. A second transistor (e.g., C-FET shown in FIG. 2) may be coupled between the voltage sense node and the battery port. The second transistor may be on when the charger is to supply charging current to the battery port. In some aspects, the second transistor may off when the power supply circuit enters and exits the current limit condition for the charger or the battery supplement mode causing the voltage sense node to be a high-impedance node.

In some aspects, the first transistor may be turned on based on entering the current limit condition and the first transistor may be turned off based on exiting the current limit condition (e.g., as described with respect to FIG. 3). In some cases, the first transistor is on when entering and exiting the current limit condition (e.g., as described with respect to FIG. 4).

In some aspects, based on the second transistor turning on to charge the battery, the ripple reduction circuit may increase the voltage limit to allow the charger to generate a regulated output voltage that is greater than a voltage of the battery (e.g., as described with respect to FIG. 6).

In some aspects, the frequency detector may generate a frequency detection signal based on the frequency. The power supply circuit may generate, (e.g., via the filter 504 of FIG. 5) a filtered frequency signal based on the frequency detection signal. To determine whether the frequency is within the configured frequency range, the frequency comparator may determine whether the filtered frequency signal is within the configured frequency range.

### EXAMPLE ASPECTS

In addition to the various aspects described above, specific combinations of aspects are within the scope of the disclosure, some of which are detailed below:
Aspect 1: A power supply circuit comprising: a charger coupled to a battery port configured to be coupled to a battery; a frequency detector configured to detect a frequency at which the power supply circuit enters and exits (a) a current limit condition for the charger or (b) a battery supplement mode in which the battery is configured to supplement power provided to a load by the charger; a frequency comparator configured to determine whether the frequency is within a configured frequency range; and a ripple reduction circuit configured to decrease a current or voltage limit associated with the charger based on the frequency being within the configured frequency range.
Aspect 2: The power supply circuit of Aspect 1, wherein: a voltage ripple is generated at an output of the charger each time the power supply circuit exits the current limit condition or the battery supplement mode, yielding a series of voltage ripples at a ripple frequency that is within the configured frequency range; and the ripple reduction circuit is configured to decrease the current or voltage limit to prevent the series of voltage ripples from occurring at the ripple frequency that is within the configured frequency range.
Aspect 3: The power supply circuit of Aspect 1 or 2, wherein, to decrease the current or voltage limit, the ripple reduction circuit is configured to decrease the current or voltage limit by discrete steps.
Aspect 4: The power supply circuit according to any of Aspects 1-3, wherein the ripple reduction circuit is configured to decrease the current or voltage limit until the frequency is no longer within the configured frequency range.
Aspect 5: The power supply circuit of Aspect 4, wherein the ripple reduction circuit is configured to increase the current or voltage limit after the current or voltage limit is decreased.
Aspect 6: The power supply circuit of Aspect 5, wherein the ripple reduction circuit is configured to increase the current or voltage limit until: the current or voltage limit reaches a maximum value for the current or voltage limit; the frequency at which the power supply circuit enters and exits the current limit condition or the battery supplement mode is determined to be within the configured frequency range while increasing the current or voltage limit; or a discharge current from the battery to supplement power to the load reaches zero.
Aspect 7: The power supply circuit of Aspect 5 or 6, wherein the ripple reduction circuit is configured to: decrease the current or voltage limit using a first set of discrete steps with a first delay between each of the first set of discrete steps; and increase the current or voltage limit using a second set of discrete steps with a second delay between each of the second set of discrete steps, the second delay being greater than the first delay.
Aspect 8: The power supply circuit according to any of Aspects 1-7, wherein the current limit condition comprises an input current limit condition of the charger.
Aspect 9: The power supply circuit of Aspect 8, wherein the charger is configured to enter the input current limit condition based on a maximum of an average input current to the charger exceeding an input current limit.
Aspect 10: The power supply circuit according to any of Aspects 1-9, wherein the voltage limit comprises a maximum of a regulated voltage generated by the charger, the charger being configured to generate the regulated voltage at a voltage output node of the charger based on the maximum of the regulated voltage.
Aspect 11: The power supply circuit according to any of Aspects 1-10, wherein the ripple reduction circuit is configured to decrease the current or voltage limit in order to increase an amount of current provided from the battery to the load.
Aspect 12: The power supply circuit according to any of Aspects 1-11, wherein the configured frequency range comprises an audible frequency range.
Aspect 13: The power supply circuit according to any of Aspects 1-12, further comprising: a first transistor coupled between an output of the charger and a voltage sense node of the power supply circuit; and a second transistor coupled between the voltage sense node and the battery port.
Aspect 14: The power supply circuit of Aspect 13, wherein: the first transistor is configured to be turned on based on entering the current limit condition; and the first transistor is configured to be turned off based on exiting the current limit condition.
Aspect 15: The power supply circuit of Aspect 13 or 14, wherein the second transistor is configured to be off when the power supply circuit enters and exits the current limit condition for the charger or the battery supplement mode causing the voltage sense node to be a high-impedance node.
Aspect 16: The power supply circuit according to any of Aspects 13-15, wherein the first transistor is configured to be on when entering and exiting the current limit condition.
Aspect 17: The power supply circuit according to any of Aspects 13-16, wherein the second transistor is configured to be on when the charger is to supply charging current to the battery port.
Aspect 18: The power supply circuit according to any of Aspects 13-17, wherein, based on the second transistor turning on to charge the battery, the ripple reduction circuit is configured to increase the voltage limit to allow the charger to generate a regulated output voltage that is greater than a voltage of the battery.
Aspect 19: The power supply circuit according to any of Aspects 1-18, wherein: the frequency detector is configured to generate a frequency detection signal based on the frequency; the power supply circuit further comprises a filter configured to generate a filtered frequency signal based on the frequency detection signal; and to determine whether the frequency is within the configured frequency range, the frequency comparator is configured to determine whether the filtered frequency signal is within the configured frequency range.
Aspect 20: A method for supplying power, comprising: detecting a frequency at which a power supply circuit enters and exits (a) a current limit condition for a charger or (b) a battery supplement mode in which a battery supplements power provided to a load by the charger; determining whether the frequency is within a configured frequency range; and decreasing a current or voltage limit associated with the charger based on the frequency being within the configured frequency range.
Aspect 21: The method of Aspect 20, wherein: a voltage ripple is generated at an output of the charger each time the power supply circuit exits the current limit condition or the battery supplement mode, yielding a series of voltage ripples at a ripple frequency that is within the configured frequency range; and the current or voltage limit is decreased to prevent the series of voltage ripples from occurring at the ripple frequency that is within the configured frequency range.
Aspect 22: The method of Aspect 20 or 21, wherein the current or voltage limit is decreased by discrete steps.
Aspect 23: The method according to any of Aspects 20-22, wherein the current or voltage limit is decreased until the frequency is no longer within the configured frequency range.
Aspect 24: The method of Aspect 23, further comprising increasing the current or voltage limit after the current or voltage limit is decreased.
Aspect 25: The method of Aspect 24, wherein the current or voltage limit is increased until: the current or voltage limit reaches a maximum value for the current or voltage limit; the frequency at which the power supply circuit enters and exits the current limit condition or the battery supplement mode is determined to be within the configured frequency range while increasing the current or voltage limit; or a discharge current from the battery to supplement power to the load reaches zero.
Aspect 26: The method of Aspect 24 or 25, wherein: the current or voltage limit is decreased using a first set of discrete steps with a first delay between each of the first set of discrete steps; and the current or voltage limit is increased using a second set of discrete steps with a second delay between each of the second set of discrete steps, the second delay being greater than the first delay.
Aspect 27: The method according to any of Aspects 20-26, wherein the current limit condition comprises an input current limit condition of the charger.
Aspect 28: The method according to any of Aspects 20-27, wherein the voltage limit comprises a maximum of a regulated voltage generated at a voltage output node of the charger.
Aspect 29: An apparatus for supplying power, comprising: means for detecting a frequency at which a power supply circuit enters and exits (a) a current limit condition for a charger or (b) a battery supplement mode in which a battery supplements power provided to a load by the charger; means for determining whether the frequency is within a configured frequency range; and means for decreasing a current or voltage limit associated with the charger based on the frequency being within the configured frequency range.
Aspect 30: An electronic device, comprising: a battery; one or more circuits; and a power supply circuit comprising: a charger coupled to the battery; a frequency detector configured to detect a frequency at which the power supply circuit enters and exits (a) a current limit condition for the charger or (b) a battery supplement mode in which the battery is configured to supplement power provided to the one or more circuits by the charger; a frequency comparator configured to determine whether the frequency is within a configured frequency range; and a ripple reduction circuit configured to decrease a current or voltage limit associated with the charger based on the frequency being within the configured frequency range.

### Additional Considerations

The various operations of methods described above may be performed by any suitable means capable of performing the corresponding functions. The means may include various hardware and/or software component(s) and/or module(s), including, but not limited to a circuit, an application-specific integrated circuit (ASIC), or processor. Generally, where there are operations illustrated in figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like. In some aspects, means for detecting a frequency may include, for example, a frequency detector such as the frequency detector 502 of FIG. 5, means for determining may include a frequency comparator such as the frequency comparator 506 of FIG. 5, and means for decreasing may include a ripple reduction circuit such as the ripple reduction circuit 508 or the ripple reduction circuit 510 of FIG. 5.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A power supply circuit comprising:
a charger coupled to a battery port configured to be coupled to a battery;
a frequency detector configured to detect a frequency at which the power supply circuit enters and exits (a) a current limit condition for the charger or (b) a battery supplement mode in which the battery is configured to supplement power provided to a load by the charger;
a frequency comparator configured to determine whether the frequency is within a configured frequency range; and
a ripple reduction circuit configured to decrease a current or voltage limit associated with the charger based on the frequency being within the configured frequency range.

2. The power supply circuit of claim 1, wherein:
a voltage ripple is generated at an output of the charger each time the power supply circuit exits the current limit condition or the battery supplement mode, yielding a series of voltage ripples at a ripple frequency that is within the configured frequency range; and
the ripple reduction circuit is configured to decrease the current or voltage limit to prevent the series of voltage ripples from occurring at the ripple frequency that is within the configured frequency range.

3. The power supply circuit of claim 1, wherein, to decrease the current or voltage limit, the ripple reduction circuit is configured to decrease the current or voltage limit by discrete steps.

4. The power supply circuit of claim 1, wherein the ripple reduction circuit is configured to decrease the current or voltage limit until the frequency is no longer within the configured frequency range.

5. The power supply circuit of claim 4, wherein the ripple reduction circuit is configured to increase the current or voltage limit after the current or voltage limit is decreased.

6. The power supply circuit of claim 5, wherein the ripple reduction circuit is configured to increase the current or voltage limit until:
the current or voltage limit reaches a maximum value for the current or voltage limit;
the frequency at which the power supply circuit enters and exits the current limit condition or the battery supplement mode is determined to be within the configured frequency range while increasing the current or voltage limit; or
a discharge current from the battery to supplement power to the load reaches zero.

7. The power supply circuit of claim 5, wherein the ripple reduction circuit is configured to:
decrease the current or voltage limit using a first set of discrete steps with a first delay between each of the first set of discrete steps; and
increase the current or voltage limit using a second set of discrete steps with a second delay between each of the second set of discrete steps, the second delay being greater than the first delay.

8. The power supply circuit of claim 1, wherein the current limit condition comprises an input current limit condition of the charger.

9. The power supply circuit of claim 8, wherein the charger is configured to enter the input current limit condition based on a maximum of an average input current to the charger exceeding an input current limit.

10. The power supply circuit of claim 1, wherein the voltage limit comprises a maximum of a regulated voltage generated by the charger, the charger being configured to generate the regulated voltage at a voltage output node of the charger based on the maximum of the regulated voltage.

11. The power supply circuit of claim 1, wherein the ripple reduction circuit is configured to decrease the current or voltage limit in order to increase an amount of current provided from the battery to the load.

12. The power supply circuit of claim 1, wherein the configured frequency range comprises an audible frequency range.

13. The power supply circuit of claim 1, further comprising:
a first transistor coupled between an output of the charger and a voltage sense node of the power supply circuit; and
a second transistor coupled between the voltage sense node and the battery port.

14. The power supply circuit of claim 13, wherein:
the first transistor is configured to be turned on based on entering the current limit condition; and
the first transistor is configured to be turned off based on exiting the current limit condition.

15. The power supply circuit of claim 13, wherein the second transistor is configured to be off when the power supply circuit enters and exits the current limit condition for the charger or the battery supplement mode causing the voltage sense node to be a high-impedance node.

16. The power supply circuit of claim 13, wherein the first transistor is configured to be on when entering and exiting the current limit condition.

17. The power supply circuit of claim 13, wherein the second transistor is configured to be on when the charger is to supply charging current to the battery port.

18. The power supply circuit of claim 13, wherein, based on the second transistor turning on to charge the battery, the ripple reduction circuit is configured to increase the voltage limit to allow the charger to generate a regulated output voltage that is greater than a voltage of the battery.

19. The power supply circuit of claim 1, wherein:
the frequency detector is configured to generate a frequency detection signal based on the frequency;
the power supply circuit further comprises a filter configured to generate a filtered frequency signal based on the frequency detection signal; and
to determine whether the frequency is within the configured frequency range, the frequency comparator is configured to determine whether the filtered frequency signal is within the configured frequency range.

20. A method for supplying power, comprising:
detecting a frequency at which a power supply circuit enters and exits (a) a current limit condition for a charger or (b) a battery supplement mode in which a battery supplements power provided to a load by the charger;
determining whether the frequency is within a configured frequency range; and
decreasing a current or voltage limit associated with the charger based on the frequency being within the configured frequency range.

21. The method of claim 20, wherein:
a voltage ripple is generated at an output of the charger each time the power supply circuit exits the current limit condition or the battery supplement mode, yielding a series of voltage ripples at a ripple frequency that is within the configured frequency range; and
the current or voltage limit is decreased to prevent the series of voltage ripples from occurring at the ripple frequency that is within the configured frequency range.

22. The method of claim 20, wherein the current or voltage limit is decreased by discrete steps.

23. The method of claim 20, wherein the current or voltage limit is decreased until the frequency is no longer within the configured frequency range.

24. The method of claim 23, further comprising increasing the current or voltage limit after the current or voltage limit is decreased.

25. The method of claim 24, wherein the current or voltage limit is increased until:
the current or voltage limit reaches a maximum value for the current or voltage limit;
the frequency at which the power supply circuit enters and exits the current limit condition or the battery supplement mode is determined to be within the configured frequency range while increasing the current or voltage limit; or
a discharge current from the battery to supplement power to the load reaches zero.

26. The method of claim 24, wherein:
the current or voltage limit is decreased using a first set of discrete steps with a first delay between each of the first set of discrete steps; and
the current or voltage limit is increased using a second set of discrete steps with a second delay between each of the second set of discrete steps, the second delay being greater than the first delay.

27. The method of claim 20, wherein the current limit condition comprises an input current limit condition of the charger.

28. The method of claim 20, wherein the voltage limit comprises a maximum of a regulated voltage generated at a voltage output node of the charger.

29. An apparatus for supplying power, comprising:
means for detecting a frequency at which a power supply circuit enters and exits (a) a current limit condition for a charger or (b) a battery supplement mode in which a battery supplements power provided to a load by the charger;
means for determining whether the frequency is within a configured frequency range; and
means for decreasing a current or voltage limit associated with the charger based on the frequency being within the configured frequency range.

30. An electronic device, comprising:
a battery;
one or more circuits; and
a power supply circuit comprising:
a charger coupled to the battery;
a frequency detector configured to detect a frequency at which the power supply circuit enters and exits (a) a current limit condition for the charger or (b) a battery supplement mode in which the battery is configured to supplement power provided to the one or more circuits by the charger;
a frequency comparator configured to determine whether the frequency is within a configured frequency range; and
a ripple reduction circuit configured to decrease a current or voltage limit associated with the charger based on the frequency being within the configured frequency range.
